(19) United States
(12) Patent Application Publication
(10) Pub. No.: US 2024/0113841 A1
(43) Pub. Date: Apr. 4, 2024

(54) Generation of a Channel State Information (CSI) Reporting Using an Artificial Intelligence Model

(71) Applicant: Apple Inc., Cupertino, CA (US)

(72) Inventors: Huaning Niu, San Jose, CA (US); Weidong Yang, San Diego, CA (US); Chunxuan Ye, San Diego, CA (US); Dawei Zhang, Saratoga, CA (US); Wei Zeng, Saratoga, CA (US); Oghenekome Oteri, San Diego, CA (US); Ankit Bhamri, Bad Nauheim (DE); Hong He, San Jose, CA (US)

(21) Appl. No.: 17/958,207

(22) Filed: Sep. 30, 2022

(51) Int. Cl. H04L 5/00; H04B 7/06; H04W 24/02

(52) U.S. Cl. CPC H04L 5/0057; H04B 7/0626; H04W 24/02

(57) ABSTRACT

A user equipment (UE) includes a transceiver and a processor configured to receive, from a network via the transceiver, a configuration of channel state information (CSI) report characteristics. The CSI report characteristics include one or more of: a maximum size of a CSI report payload, a maximum number of bits per layer or rank, a neural network (NN) identification (ID), or an expected CSI report content type. The processor is configured to generate a CSI report, in accordance with the received CSI report characteristics, to transmit to the network via the transceiver.

### TECHNICAL FIELD

This application relates generally to wireless communication systems, including methods and systems for channel state information (CSI) feedback using an artificial intelligence (AI) model.

### BACKGROUND

Wireless mobile communication technology uses various standards and protocols to transmit data between a network device (e.g., a base station) and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates various example formats of a CSI report generated by a user equipment (UE) based on CSI report characteristics including a maximum size of a CSI report payload, according to embodiments described herein.

FIG. 3 illustrates an example method of generating a CSI report, according to embodiments described herein.

FIG. 4 illustrates various example formats of a CSI report generated by a UE based on CSI report characteristics including a maximum size of a CSI report payload and a maximum number of bits per layer or rank in the CSI report, according to embodiments described herein.

FIG. 5A illustrates various example formats of a CSI report generated by a UE that does not support punctures in a CSI report, according to embodiments described herein.

FIG. 5B illustrates various example formats of a CSI report generated by a UE that supports punctures in a CSI report, according to embodiments described herein.

FIG. 6 illustrates an example flow-chart of operations that may be performed by a user equipment (UE), according to embodiments described herein.

FIG. 7 illustrates an example format of a CSI report generated based on channel based feedback, according to embodiments described herein.

FIG. 8 illustrates an example flow-chart of operations that may be performed by a network device of a RAN, according to embodiments described herein.

FIG. 9 illustrates an example architecture of a wireless communication system, according to embodiments disclosed herein.

FIG. 10 illustrates a system for performing signaling between a wireless device and a network device, according to embodiments disclosed herein.

### DETAILED DESCRIPTION

Various embodiments in the present disclosure are directed to methods and systems for generating channel state information (CSI) feedback (or CSI compression feedback or a CSI report) based on an artificial intelligence (AI) model. AI model-based CSI feedback may reduce overhead, improve accuracy, and improve channel prediction. Currently, for CSI feedback, the AI model may be trained according to various frameworks that include type-1 (joint training of the two-sided AI model at a single entity, e.g., a UE or a network), type-2 (joint training of the two-sided AI model at a UE and a network), and type-3 (separate training at a network and a UE with the UE generating a CSI report and the network performing CSI reconstruction).

As described in the present disclosure, joint training may include training a model for generating a CSI report at a UE-side and a model for reconstruction at a network-side in the same loop for forward propagation and backward propagation. Further, the joint training may be performed using a single node or across multiple nodes, which, for example, may be performed using a gradient exchange between nodes. A separate training may include training a model on a UE-side and a model on a network-side sequentially, in which the UE-side or the network-side model may be trained first, or may be performed in parallel. Other frameworks, in addition to the type-1, the type-2, and/or the type-3, and not mentioned in the present disclosure may also be used.

Various embodiments in the present disclosure describe generating a CSI report based on various configurations for CSI report generation (e.g., a payload size of a CSI report, a format of a CSI report, and so on) based on a precoder matrix index (PMI) feedback and/or channel feedback. As described herein, generating a CSI report may include determining a channel quality indicator (CQI) and/or a rank indicator (RI). The CQI and/or the RI in the CSI report is used for selecting a transmission layer for transmission in a downlink (DL) direction.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

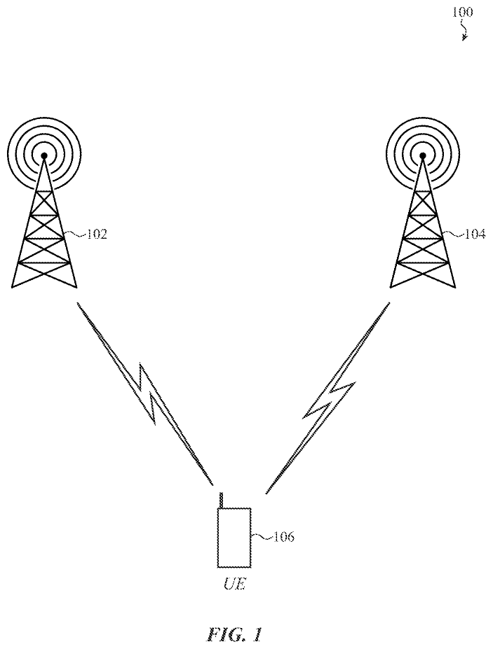

FIG. 1 shows an example wireless communication system, according to embodiments described herein. As shown in FIG. 1, a wireless communication system 100 may include a network device 102, a network device 104, and a user equipment (UE) 106. The UE 106 may be communicatively coupled with the network device 102 and/or the network device 104 to transmit data in an uplink (UL) direction and/or to receive data in a downlink (DL) direction. In some embodiments, the network devices 102 and 104 may be an eNb, an eNodeB, a gNodeB, or an access point (AP) in a radio access network (RAN) and may support one or more radio access technologies, such as 4G, 5G, 5G new radio (5G NR), and so on. The UE 106 may be a phone, a smart phone, a tablet, a smartwatch, an Internet-of-Things (IoT), a vehicle, and so on.

A CSI report describes a state of a channel. A UE may transmit a CSI report to a network device as feedback. The CSI report may include several parameters, such as a channel quality indicator (CQI), a precoding matrix indicator (PMI) with different codebook sets, and a rank indicator (RI). The UE may use a channel state information reference signal (CSI-RS) to measure CSI feedback and generate a CSI report. Upon receiving the CSI report, the network device may schedule data transmission in a DL direction over a specific transmission layer.

In some embodiments, performance monitoring for CSI feedback may be performed using a two-sided model at the UE-side and at the network-side. The UE may generate a CSI report based on the performance monitoring using an AI model. The UE may generate the CSI report based on a configuration of a CSI report (or a configuration of CSI report characteristics), as received from a network device, and transmit the CSI report to a network device. By way of a non-limiting example, the configuration of CSI report characteristics may include one or more of: a maximum size of a CSI report payload, a maximum number of bits per layer or rank, a neural network (NN) identification (ID) (or an ID of an AI model), and/or an expected CSI report content type. The NN ID identifies a particular AI model that is used by the UE for performance monitoring. A different AI model may be configured for each layer or rank for performance monitoring. Alternatively, the same AI model may be configured for each layer or rank for performance monitoring.

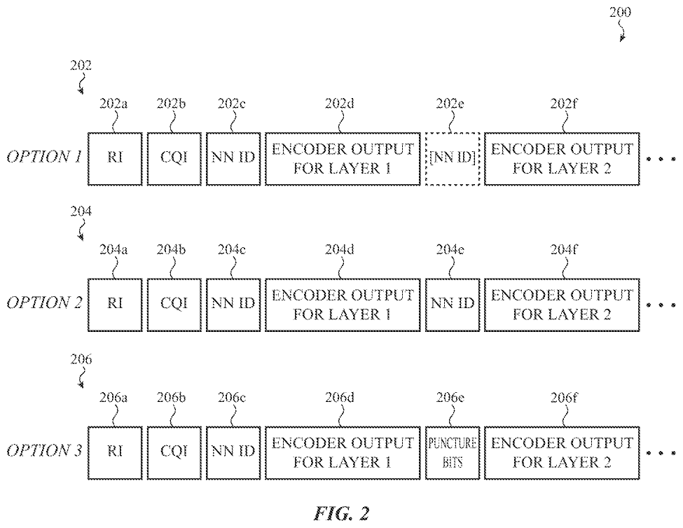

FIG. 2 illustrates various example formats of a CSI report generated by a user equipment (UE) based on CSI report configuration including a maximum size of a CSI report payload, according to embodiments described herein. For example, the network device may configure the UE for configuration of CSI report characteristics including a maximum size of a CSI report payload (e.g., max). The network device may also configure the UE so that there is an equal number of bits in the CSI report payload per layer or rank. Accordingly, the UE may select an AI model having an AI encoder function that generates a CSI report of a payload that is equal for each layer or rank. In other words, the UE may select an AI model having an AI encoder function that generates CSI report output that is less than max/N size per layer or rank. In FIG. 2, a diagram 200 shows various example formats of a CSI report.

A CSI report format for a UE configured with a maximum size of a CSI report and an equal number of bits per layer or rank may be as shown in FIG. 2 as 202. The CSI report with a maximum size of a CSI report and an equal number of bits per layer or rank 202 may include a RI 202a, a CQI 202b, a NN ID 202c, and an encoder output for a first layer (or layer 1) 202d. In some embodiments, and by way of a non-limiting example, the UE may train and/or use the same AI model for all layers or ranks, and a NN ID (or AI model ID) of the AI model may be included in the CSI report as 202c. However, if different AI models are trained and/or used for each layer or rank, that NN ID corresponding to a second layer or rank may be included in the CSI report as 202e. Thus, a NN ID of an AI model associated with the second layer or rank may be optional. The CSI report 202 may include an encoder output for a second layer (or layer 2) 202f. Even though not shown in the CSI report 202, the encoder output for the second layer 202f may be followed by a NN ID of an AI model associated with a third layer or rank if a different AI model is trained and/or used for the third layer or rank, and an encoder output for a third layer (or layer 3), and so on. The encoder output for the first layer (or layer 1) 202d, the encoder output for the second layer (or layer 2) 202f may be of the same size. Further, the total size of the CSI report payload including the RI 202a, the CQI 202b, the NN ID 202c, the encoder output for the first layer 202d, the NN ID 202e, the encoder output for the second layer 202f, and so on does not exceed the maximum size of the CSI report payload (e.g., max) configured by the network device.

In some embodiments, and by way of a non-limiting example, the network device may configure the UE for configuration of CSI report characteristics including a maximum size of a CSI report payload (e.g., max). The network device may also configure the UE that there are a different number of bits in the CSI report payload per layer or rank. Accordingly, the UE may select a respective AI model corresponding to each layer or rank. The respective AI model for each layer or rank may have an AI encoder function that generates an encoder output for that layer or rank, which when added with AI encoder function outputs of other layers or ranks, does not exceed the maximum size of a CSI report payload (e.g., max). Further, an AI encoder function output for one layer or rank may be different from an AI encoder function output for another layer or rank. In other words, if the maximum size of a CSI report payload is max, and for four layers or rank, the UE may select four different AI models with their AI encoder functions generating output K1, K2, K3, and K4 for layers 1-4, respectively, where a total sum of K1, K2, K3, and K4 does not exceed the configured maximum size of the CSI report payload (e.g., max).

A CSI report format for a UE configured with a maximum size of a CSI report and a different number of bits per layer or rank may be as shown in FIG. 2 as 204. The CSI report with a maximum size of a CSI report and a different number of bits per layer or rank 204 may include a RI 204a, a CQI 204b, a NN ID 204c, and an encoder output for a first layer (or layer 1) 204d. The CSI report 204 may also include a NN ID corresponding to a second layer or rank as 204e. The CSI report 204 may include an encoder output for a second layer (or layer 2) 202f. Even though not shown in the CSI report 204, the encoder output for the second layer 202f may be followed by a NN ID of an AI model associated with a third layer or rank, and an encoder output for a third layer (or layer 3), and so on. The encoder output for the first layer (or layer 1) 204d and the encoder output for the second layer (or layer 2) 204f may be of a different size. Thus, the CSI report 204 may include RI, CQI per subband or wideband, and a NN ID for each layer or rank, in addition to an encoder function output corresponding to each layer or rank.

In some embodiments, a network (or a network device) may not configure a number of bits per layer, and a UE may determine, according to UE implementation, whether the CSI report be generated with equal or different number of bits per layer or rank, and/or a maximum number of bits per layer. Accordingly, the UE may have the maximum or better control of the AI model selection, with the limitation of maximum payload size of the generated CSI report fits into a physical uplink control channel (PUCCH) format.

In some embodiments, the UE may be configured with a list of NN IDs by a network device, e.g., via radio resource control (RRC) signaling. The NN ID in the CSI report may be an index of a NN ID in the configured list of NN IDs to reduce a payload size of the CSI report. If the list of NN IDs is configured to include 8 NN IDs, then the NN ID field in the CSI report may be of 3-bits, for example.

In some embodiments, and by way of a non-limiting example, the network device may configure the UE for configuration of CSI report characteristics including a maximum size of a CSI report payload (e.g., max). The network device may also configure the UE so that there are the same or a different number of bits in the CSI report payload per layer or rank. The UE may select one or more AI models as described above which can generate a CSI report payload which does not exceed the maximum size of a CSI report payload (e.g., max), and the encoder function output for each layer or rank is either the same or different as configured by the network device. The UE may be further configured to generate a CSI report with puncturing. Accordingly, if the UE supports puncturing, the UE may indicate actual bits and/or puncture bit(s) number(s) in the CSI report. A CSI report with a different number of bits for each layer or rank with puncturing is shown in FIG. 2 as 206. The CSI report 206 may include a RI 206a, a CQI 206b, a NN ID 206c, and an encoder output for a first layer (or layer 1) 206d. The CSI report 206 may also include puncture bits 206e followed by an encoder output for a second layer (or layer 2) 206f. Even though not shown in the CSI report 204, the encoder output for the second layer 202f may be followed by puncture bits, and an encoder output for a third layer (or layer 3), and so on. The encoder output for the first layer (or layer 1) 206d, and the encoder output for the second layer (or layer 2) 206f may be of a different size.

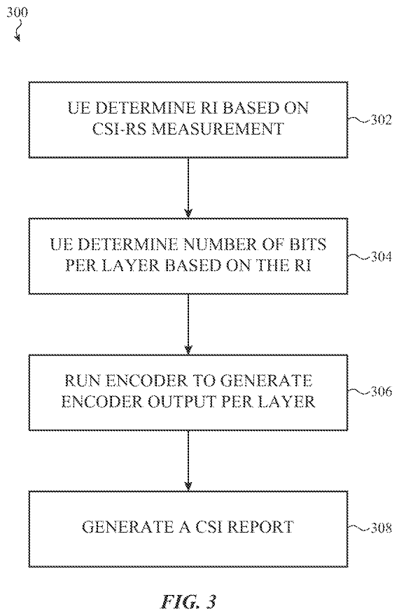

FIG. 3 illustrates an example method of generating a CSI report, according to embodiments described herein. As shown in an example method 300, at 302, a UE may determine a RI based on channel state information reference signal (CSI-RS) measurements. The RI suggests number of multiple input multiple output (MIMO) layers of a multiple input multiple output (MIMO) system. By way of a non-limiting example, the RI may be determined using a traditional method based on a wideband covariant matrix. However, other methods and/or matrixes may also be used.

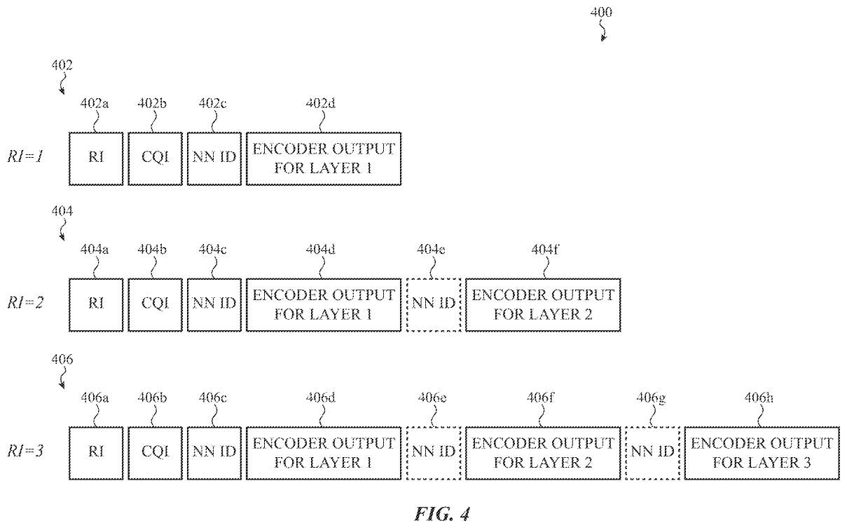

At 304, the UE may determine a number of bits per layer or rank based on the RI determined at 302 (as described using FIG. 4). As described herein using FIG. 2, the UE may be configured by a network device for a number of bits for each layer or rank, and the UE may select one or more AI models (or one or more AI encoder functions) as described using FIG. 2 at 306, and execute (or run) the selected one or more encoder functions. Based on an output generated by executing the selected one or more encoder functions, at 308, the UE may generate a CSI report. As shown in FIG. 2, the generated CSI report may include a RI, a CQI per subband and/or wideband, an encoder output (or AI model output) for each layer or rank, and/or one or more NN IDs. If the UE supports puncturing, the CSI report may also include puncture bits and/or the position of the puncture bits in the CSI report.

FIG. 4 illustrates various example formats of a CSI report generated by a UE based on CSI report characteristics including a maximum size of a CSI report payload and a maximum number of bits per layer or rank in the CSI report, according to embodiments described herein. For example, the network device may configure the UE for configuration of CSI report characteristics including a maximum size of a CSI report payload (e.g., max). The network device may also configure the UE for a maximum number of bits in the CSI report payload per layer or rank. Accordingly, the UE may select an AI model having an AI encoder function based on the RI. In other words, the UE may select an AI model having an AI encoder function corresponding to each layer or rank.

In a diagram 400 shown in FIG. 4, various CSI report formats corresponding to different RIs are shown. A CSI report 402 may correspond with a RI of 1, and include a RI 402a, a CQI 402b, a NN ID 402c, and an encoder function output for layer 1 402d. The UE may select an AI model having an encoder function that outputs a maximum number of bits which is equal to or less than the configured maximum number of bits per layer or rank. A CSI report 404 may correspond with a RI of 2, and include a RI 404a, a CQI 404b, a NN ID 404c, and an encoder function output for layer 1 404d. The CSI report 404 may further include a NN ID 404e that corresponds to a second layer, and an encoder function output for layer 2 404f. Accordingly, the CSI report payload size may be almost twice when compared with a CSI report payload for a RI of 1. For a RI of 3 or 4, and UE may select a respective AI model for each layer or rank with an encoder output of for each layer or rank that is of the same or different number of bits. A CSI report 406 may correspond with a RI of 3, and include a RI 406a, a CQI 406b, a NN ID 406c, and an encoder function output for layer 1 406d. The CSI report 406 may further include a NN ID 406e that corresponds to a second layer, and an encoder function output for layer 2 406f. The CSI report 406 may further include a NN ID 406g that corresponds to a third layer, and an encoder function output for layer 3 406h.

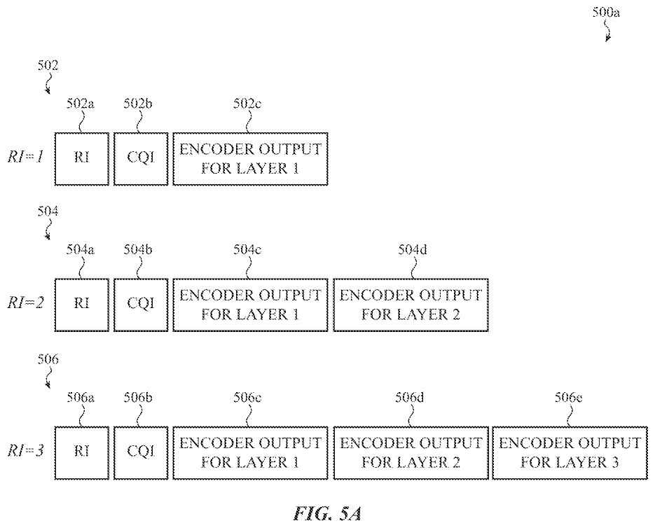

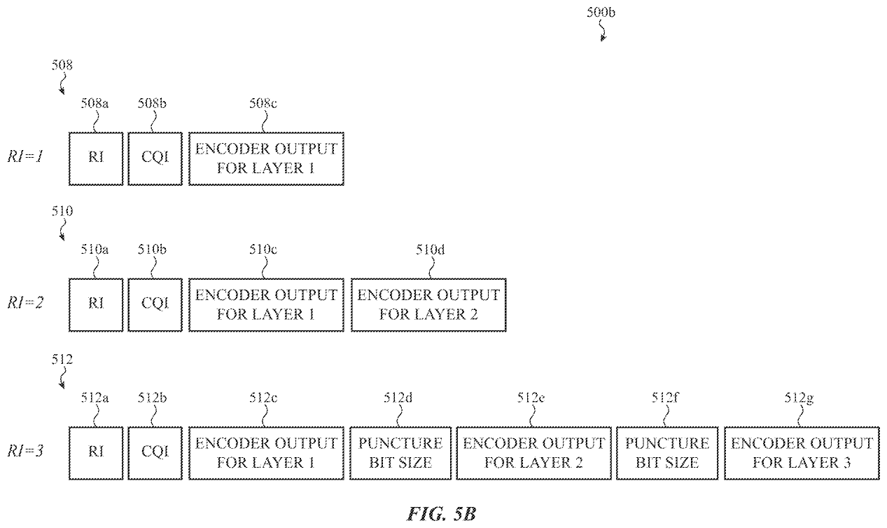

FIG. 5A illustrates various example formats of a CSI report generated by a UE that does not support punctures in a CSI report, according to embodiments described herein. In particular, various example formats of a CSI report generated by a UE and shown in a diagram 500a correspond with CSI report characteristics including a maximum size of a CSI report payload and a configured NN ID for each layer or rank. Based on the UE's inference capability and/or memory/storage capability (or capacity), the UE may be configured for the same NN ID for all layers or ranks, or a different NN ID for each layer or rank.

A CSI report 502 may correspond with a RI of 1, and include a RI 502a, a CQI 502b, and an encoder function output for layer 1 502c. The UE may select an AI model having an encoder function that outputs a maximum number of bits which is equal to or less than the configured maximum number of bits per layer or rank. A CSI report 504 may correspond with a RI of 2, and include a RI 504a, a CQI 504b, and an encoder function output for layer 1 504c. The CSI report 504 may further include an encoder function output for layer 2 504d. A CSI report 506 may correspond with a RI of 3, and include a RI 506a, a CQI 506b, and an encoder function output for layer 1 506c. The CSI report 506 may further include an encoder function output for layer 2 506d, and an encoder function output for layer 3 506e. Thus, the CSI report payload is determined based on the determined RI, or the CSI report payload size increases as the RI increases. In other words, the CSI report payload scales with the RI.

FIG. 5B illustrates various example formats of a CSI report generated by a UE that supports punctures in a CSI report, according to embodiments described herein. In particular, various example formats of a CSI report generated by a UE and shown in a diagram 500b correspond with CSI report characteristics including a maximum size of a CSI report payload and a configured NN ID for each layer or rank. Based on the UE's inference capability and/or memory/storage capability (or capacity), the UE may be configured for the same NN ID for all layers or ranks, or a different NN ID for each layer or rank.

A CSI report 508 may correspond with a RI of 1, and include a RI 508a, a CQI 508b, and an encoder function output for layer 1 508c. The UE may select an AI model having an encoder function that outputs a maximum number of bits which is equal to or less than the configured maximum number of bits per layer or rank. Since RI is 1, the CSI report 508 may not be different from a CSI report shown in FIG. 5A as 502. A CSI report 510 may correspond with a RI of 2, and include a RI 510a, a CQI 510b, and an encoder function output for layer 1 510c. The CSI report 510 may further include an encoder function output for layer 2 510d. The UE may include puncture bits in the CSI report based on the puncturing configuration, as configured by a network device. The puncturing configuration may be received by the UE using RRC signaling. By way of a non-limiting example, the puncturing configuration may not indicate to include puncture bits when RI is 2. Accordingly, as shown in the CSI report 510, puncturing bits may not be included in the CSI report. A CSI report 512 may correspond with a RI of 3, and include a RI 512a, a CQI 512b, and an encoder function output for layer 1 512c. The CSI report 512 may further include puncturing bits in accordance with the puncturing configuration, which is shown as 512d and 512f separating encoder function outputs of different layers or ranks. The CSI report 512 may accordingly include an encoder function output for layer 2 512e, and an encoder function output for layer 3 512g. In some embodiments, the UE may not be configured with a puncturing configuration, and the UE may include puncturing bits of a puncturing bits size, which is selected or determined in such a way that the CSI report's payload size does not exceed the configured maximum size of the CSI report payload.

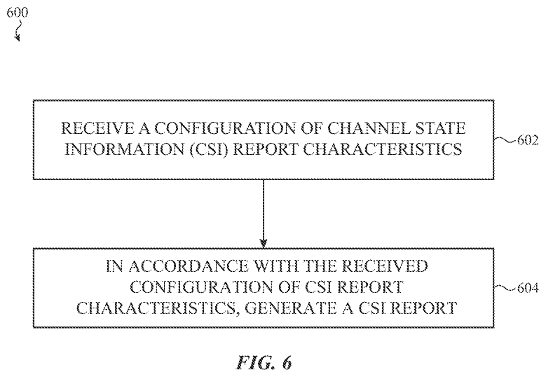

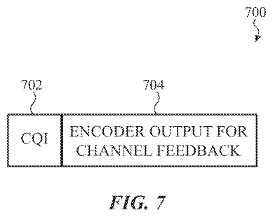

FIG. 6 illustrates an example flow-chart of operations that may be performed by a user equipment (UE), according to embodiments described herein. As shown in a flow-chart 600, at 602, the UE may receive from a network (or a network device), a configuration of CSI report characteristics. The CSI report characteristics may include one or more of: a maximum size of a CSI report payload, a maximum number of bits per layer or rank, a NN ID (corresponding to one or more layers or ranks), and an expected CSI report content type. By way of a non-limiting example, the CSI report characteristics including a list of NN IDs, and/or a particular NN ID corresponding to each layer or rank, may be specified. The expected CSI report content type may indicate to the UE whether the CSI report includes a PMI-based CSI output or a channel-based CSI output. A CSI report format based on the channel-based CSI output is described using FIG. 7.

By way of a non-limiting example, the PMI-based CSI output may be of a PMI-based CSI output that does not require spatial or frequency domain transformation. The UE may perform an eigen-vector calculation, and select an AI model (or an AI encoder function) based on the calculated eigen-vector as an input. Alternatively, the PMI-based CSI output may be of a PMI-based CSI output that requires spatial and/or frequency domain transformation. The UE may perform domain transformation based on the maximum spatial basis transformation configuration and/or the maximum frequency domain transformation configuration, and select an AI model (or an AI encoder function) based on the performed domain transformation as an input.

In some embodiments, and by way of a non-limiting example, for PMI-based CSI report generation, if the CSI reconstruction model is unknown at the UE, or the UE does not have a capability to perform CSI reconstruction model inferencing due to processing complexity or delay constraint, the CQI may be subband CQI based on ideal eigen-vector. Alternatively, a CQI may be subband CQI based on the quantized PMI, such as the CSI reconstruction model output, in case a UE knows the CSI reconstruction model and has the capability to perform reconstruction model inferencing within CSI processing time limit. The CQI subband may be configured wider than the PMI subband. Alternatively, the CQI may be wideband.

In some embodiments, and way of a non-limiting example, the channel-based CSI output may be of a channel-based CSI output that does not require spatial or frequency domain transformation. The UE may perform an AI encoder function based on the CSI-RS measurement configuration received from a network (or a network device). Alternatively, the channel-based CSI output may be of a channel-based CSI output that requires spatial and/or frequency domain transformation. The UE may perform domain transformation based on the spatial basis transformation configuration and/or frequency domain transformation configuration, and select an AI model (or an AI encoder function) based on the performed domain transformation as an input.

Other aspects of the CSI report characteristics are described in detail in the present disclosure, and therefore, those details are not repeated for brevity. At 604, the UE may generate a CSI report based on the CSI report characteristics, and transmit to the network (or the network device).

FIG. 7 illustrates an example format of a CSI report generated based on channel based feedback, according to embodiments described herein. CSI report formats shown in FIG. 2, FIG. 4, FIG. 5A, and/or FIG. 5B are based on PMI-based CSI output. A CSI report format 700 may correspond with a CSI report format that is based on channel-based feedback. The CSI report for channel-based feedback may include a CQI 702, and an encoder function output for channel feedback 704. By way of a non-limiting example, a payload size of the CSI report and/or a NN ID (of the encoder function to use) may be configured by a network (or a networking device). The CSI report payload size (or the encoder output channel feedback size) may not be based on RI, but rather be determined based on a number of transmitting or receiving antenna ports at the UE.

In some embodiments, for channel-based CSI report generation, the CQI may be subband CQI assuming open loop MIMO, and the CQI may reflect an inter-cell interference level. Additionally, or alternatively, the CQI may be subband CQI based on a perfect (or an ideal) eigen-vector. The CQI subband may be configured wider than the channel feedback subband size. In some embodiments, the CQI may be wideband.

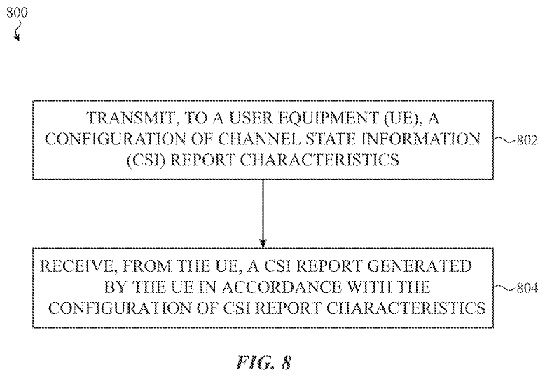

FIG. 8 illustrates an example flow-chart of operations that may be performed by a network device of a RAN, according to embodiments described herein. A shown in a flow-chart 800, at 802, a network device (e.g., a base station) may transmit, to a UE, a configuration of CSI report characteristics. The CSI report characteristics may include one or more of: a maximum size of a CSI report payload, a maximum number of bits per layer or rank, a NN ID (corresponding to one or more layers or ranks), and an expected CSI report content type. By way of a non-limiting example, the CSI report characteristics may include a list of NN IDs, and/or a particular NN ID corresponding to each layer or rank may be specified. The expected CSI report content type may indicate to the UE whether the CSI report includes a PMI-based CSI output or a channel-based CSI output. At 804, the network device may receive, from the UE, a CSI report generated by the UE in accordance with the transmitted CSI report characteristics. Since generation of the CSI report of various formats based on the CSI report characteristics transmitted at 802 is described in detail in the present disclosure, those details are not repeated for brevity.

Embodiments contemplated herein include an apparatus having means to perform one or more elements of the method 600 or 800. In the context of method 600, the apparatus may be, for example, an apparatus of a UE (such as a wireless device 1002 that is a UE, as described herein). In the context of method 600, the apparatus may be, for example, an apparatus of a network device (such as a network device 1020, as described herein).

Embodiments contemplated herein include one or more non-transitory computer-readable media storing instructions to cause an electronic device, upon execution of the instructions by one or more processors of the electronic device, to perform one or more elements of the method 600 or 800. In the context of method 600, the non-transitory computer-readable media may be, for example, a memory of a UE (such as a memory 1006 of a wireless device 1002 that is a UE, as described herein). In the context of method 800, the non-transitory computer-readable media may be, for example, a memory of a network device (such as a memory 1024 of a network device 1020, as described herein).

Embodiments contemplated herein include an apparatus having logic, modules, or circuitry to perform one or more elements of the method 600 or 800. In the context of method 600, the apparatus may be, for example, an apparatus of a UE (such as a wireless device 1002 that is a UE, as described herein). In the context of method 800, the apparatus may be, for example, an apparatus of a network device (such as a network device 1020, as described herein).

Embodiments contemplated herein include an apparatus having one or more processors and one or more computer-readable media, using or storing instructions that, when executed by the one or more processors, cause the one or more processors to perform one or more elements of the method 600 or 800. In the context of method 600, the apparatus may be, for example, an apparatus of a UE (such as a wireless device 1002 that is a UE, as described herein). In the context of the method 800, the apparatus may be, for example, an apparatus of a network device (such as a network device 1020, as described herein).

Embodiments contemplated herein include a signal as described in or related to one or more elements of the method 600 or 800.

Embodiments contemplated herein include a computer program or computer program product having instructions, wherein execution of the program by a processor causes the processor to carry out one or more elements of the method 600 or 800. In the context of method 600, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein). In the context of method 800, the processor may be a processor of a network device (such as a processor(s) 1022 of a network device 1020, as described herein), and the instructions may be, for example, located in the processor and/or on a memory of the network device (such as a memory 1024 of a network device 1020, as described herein).

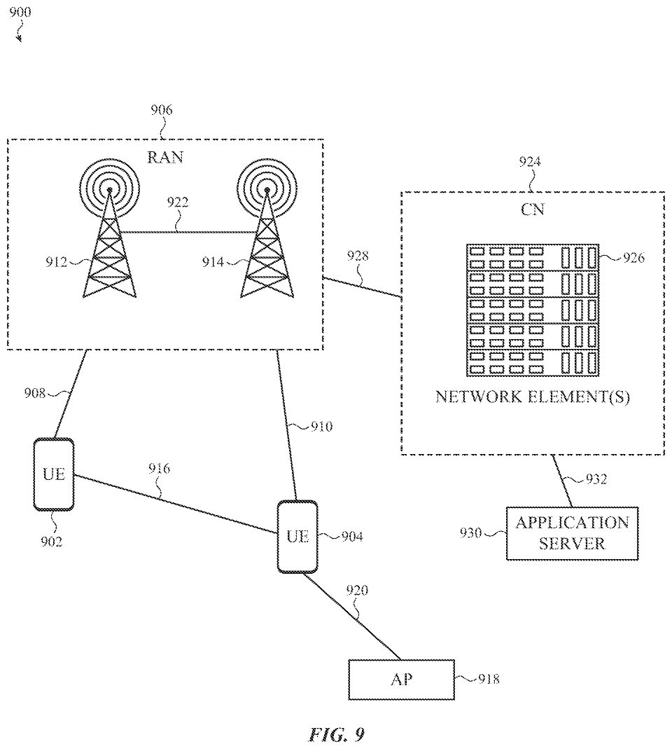

FIG. 9 illustrates an example architecture of a wireless communication system 900, according to embodiments disclosed herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

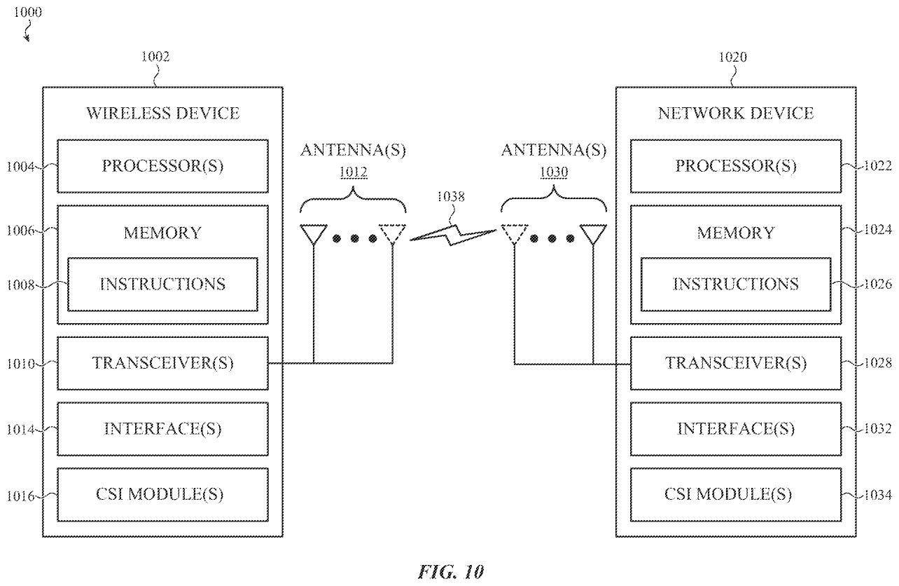

FIG. 10 illustrates a system 1000 for performing signaling 1038 between a wireless device 1002 and a network device 1020, according to embodiments disclosed herein. The system 1000 may be a portion of a wireless communication system as herein described. The wireless device 1002 may be, for example, a UE of a wireless communication system. The network device 1020 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1038) to and/or from the wireless device 1002 with other devices (e.g., the network device 1020) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include one or more CSI measurement and reporting module(s) 1016 (labeled as CSI module(s) 1016 in FIG. 10). The CSI measurement and reporting module(s) 1016 may be implemented via hardware, software, or combinations thereof. For example, the CSI measurement and reporting module(s) 1016 may be implemented as a processor, circuit, and/or instructions 1008 stored in the memory 1006 and executed by the processor(s) 1004. In some examples, the CSI measurement and reporting module(s) 1016 may be integrated within the processor(s) 1004 and/or the transceiver(s) 1010. For example, the CSI measurement and reporting module(s) 1016 may be implemented by a combination of software components (e.g., executed by a DSP or a general processor) and hardware components (e.g., logic gates and circuitry) within the processor(s) 1004 or the transceiver(s) 1010.

The CSI measurement and reporting module(s) 1016 may be used for various aspects of the present disclosure, for example, aspects of FIGS. 1-8. The CSI measurement and reporting module(s) 1016 may be configured to, for example, configure CSI measurement and reporting and transmit one or more CSI reports to another device (e.g., to the network device 1020).

The network device 1020 may include one or more processor(s) 1022. The processor(s) 1022 may execute instructions such that various operations of the network device 1020 are performed, as described herein. The processor(s) 1022 may include one or more baseband processors implemented using, for example, a CPU, a DSP, an ASIC, a controller, an FPGA device, another hardware device, a firmware device, or any combination thereof configured to perform the operations described herein.

The network device 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device 1020 may include one or more transceiver(s) 1028 that may include RF transmitter and/or receiver circuitry that use the antenna(s) 1030 of the network device 1020 to facilitate signaling (e.g., the signaling 1038) to and/or from the network device 1020 with other devices (e.g., the wireless device 1002) according to corresponding RATs.

The network device 1020 may include one or more antenna(s) 1030 (e.g., one, two, four, or more). In embodiments having multiple antenna(s) 1030, the network device 1020 may perform MIMO, digital beamforming, analog beamforming, beam steering, etc., as has been described.

The network device 1020 may include one or more interface(s) 1032. The interface(s) 1032 may be used to provide input to or output from the network device 1020. For example, a network device 1020 that is a base station may include interface(s) 1032 made up of transmitters, receivers, and other circuitry (e.g., other than the transceiver(s) 1028/antenna(s) 1030 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1020 may include one or more CSI report configuration module(s) 1034 (labeled as CSI module(s) 1034 in FIG. 10). The CSI report configuration module(s) 1034 may be implemented via hardware, software, or combinations thereof. For example, the CSI report configuration module(s) 1034 may be implemented as a processor, circuit, and/or instructions 1026 stored in the memory 1024 and executed by the processor(s) 1022. In some examples, the CSI report configuration module(s) 1034 may be integrated within the processor(s) 1022 and/or the transceiver(s) 1028. For example, the CSI report configuration module(s) 1034 may be implemented by a combination of software components (e.g., executed by a DSP or a general processor) and hardware components (e.g., logic gates and circuitry) within the processor(s) 1022 or the transceiver(s) 1028.

The CSI report configuration module(s) 1034 may be used for various aspects of the present disclosure, for example, aspects of FIGS. 1-8. The CSI report configuration module(s) 1034 may configure CSI reports that are to be transmitted by another device (e.g., the wireless device 1002).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver; and
a processor configured to:
receive, from a network via the transceiver, a configuration of channel state information (CSI) report characteristics, the configuration of CSI report characteristics including one or more of:
a maximum size of a CSI report payload;
a maximum number of bits per layer or rank;
a neural network (NN) identification (ID); or
an expected CSI report content type; and
in accordance with the received configuration of CSI report characteristics, generate a CSI report to transmit to the network via the transceiver.

2. The UE of claim 1, wherein:
the configuration of CSI report characteristics include the expected CSI report content type; and
the expected CSI report content type includes a precoder matrix indicator (PMI)-based CSI output or a channel-based CSI output.

3. The UE of claim 1, wherein:
the configuration of CSI report characteristics include the expected CSI report content type;
the expected CSI report content type is a precoder matrix indicator (PMI)-based CSI output without spatial or frequency domain transformation;
the processor is configured to:
perform an eigen-vector calculation; and
select an artificial intelligence (AI) model based on an eigen-vector as an input; and
the eigen-vector is based on the performed eigen-vector calculation.

4. The UE of claim 1, wherein:
the configuration of CSI report characteristics include the expected CSI report content type;
the expected CSI report content type is a precoder matrix indicator (PMI)-based CSI output with spatial basis or frequency domain basis; and
the processor is configured to:
perform a domain transformation based on the spatial basis or the frequency domain basis; and
select an artificial intelligence (AI) model based on the performed domain transformed as an input.

5. The UE of claim 1, wherein:
the configuration of CSI report characteristics include the expected CSI report content type;
the expected CSI report content type is a channel-based CSI output without spatial or frequency domain transformation; and
the processor is configured to:
receive a CSI reference signal (CSI-RS) measurement configuration; and
perform an artificial intelligence (AI) encoder function in accordance with the received CSI-RS measurement configuration.

6. The UE of claim 1, wherein:
the configuration of CSI report characteristics include the expected CSI report content type;
the expected CSI report content type is a channel-based CSI output with spatial basis or frequency domain basis; and
the processor is configured to:
perform a domain transformation based on the spatial basis or the frequency domain basis; and
perform an artificial intelligence (AI) encoder function of an AI model based on the performed domain transformed as an input;
the CSI report further includes a channel quality indicator (CQI), the CQI is per subband (a subband CQI) or wideband (a wideband CQI);
the subband CQI is based on an ideal eigen-vector.

7. The UE of claim 1, wherein:
the configuration of CSI report characteristics include the maximum size of the CSI report payload and the expected CSI report content type;
the expected CSI report content type is a precoder matrix indicator (PMI)-based CSI output; and
to generate the CSI report, the processor is configured to:
determine a rank indicator (RI) based on CSI reference signal (CSI-RS) measurements, the CSI-RS measurements performed based on a CSI-RS measurement configuration;
based on the determined RI, select an artificial intelligence (AI) encoder function of a respective AI model of each layer or rank;
execute the selected AI encoder function to generate AI output corresponding to each layer or rank; and
generate the CSI report including the RI, a channel quality indicator (CQI), the AI output, or an AI model identification (ID) of the respective AI model of each layer or rank.

8. The UE of claim 7, wherein:
the RI is determined using a wideband covariance matrix; and
the AI encoder function of the respective AI model of each layer or rank is selected based on a number of bits per layer or rank in the CSI report; and
the selected AI encoder function corresponding to a first layer or rank is different from the selected AI encoder function corresponding to a second layer or rank.

9. The UE of claim 7, wherein:
the AI encoder function of the respective AI model of each layer or rank is selected based on a number of bits per layer or rank in the CSI report;
the number of bits per layer or rank is an equal number of bits per layer or rank;
a total number of layers or ranks is N;
the maximum size of the CSI report payload is max; and
the selected AI encoder function has an output size of (max/N).

10. The UE of claim 7, wherein:
the AI encoder function of the respective AI model of each layer or rank is selected based on a number of bits per layer or rank in the CSI report;
the number of bits per layer or rank is a different number of bits per layer or rank;
a total number of layers or ranks is N; and
a combined output size of the selected AI encoder function corresponding to each layer or rank is less than the maximum size of the CSI report payload.

11. The UE of claim 7, wherein:
the AI encoder function of the respective AI model of each layer or rank is selected based on a number of bits per layer or rank in the CSI report;
the selected AI encoder function corresponding to each layer or rank is the same; and
the CSI report further includes one or more punctuation bit numbers separating AI encoder function output of each layer or rank in the CSI report.

12. The UE of claim 7, wherein:
the AI encoder function of the respective AI model of each layer or rank is selected based on a number of bits per layer or rank in the CSI report;
the selected AI encoder function corresponding to each layer or rank is the same; and
a size of one or more punctuations separating AI encoder function output of each layer or rank in the CSI report is configured by the network or determined by the UE to fit into the maximum size of the CSI report payload.

13. The UE of claim 7, wherein:
the AI encoder function of the respective AI model of each layer or rank is selected based on a number of bits per layer or rank in the CSI report;
the selected AI encoder function corresponding to each layer or rank is the same; and
an AI encoder output corresponding to each layer or rank scale based on the RI when a punctuation separating AI encoder function outputs of different layers or ranks in the CSI report is not configured at the UE or supported by the UE.

14. The UE of claim 7, wherein:
the processor is configured to:
train the respective AI model of each layer or rank; and
the respective AI model of each layer or rank is the same or different.

15. The UE of claim 7, wherein:
the CQI is per subband (a subband CQI) or wideband (a wideband CQI);
the subband CQI is based on an ideal eigen-vector or a quantized PMI; and
the AI model ID of the respective AI model of each layer or rank is an index and configured at the UE using a radio resource control (RRC) signaling.

16. The UE of claim 7, wherein:
the received configuration of CSI report characteristics include the maximum size of the CSI report payload with a maximum number of bits per layer in the CSI report; and
the determined RI is 1 or 2, and the respective AI model has an encoder output of the maximum number of bits per layer or rank; or
the determined RI is 3 or 4, and the respective AI model has an encoder output of for each layer or rank, the encoder output for each layer or rank is of the same or a different number of bits for each layer or rank.

17. A method, comprising:
receiving, at a user equipment (UE) from a network, a configuration of channel state information (CSI) report characteristics, the configuration of CSI report characteristics including one or more of:
a maximum size of a CSI report payload;
a maximum number of bits per layer or rank;
a neural network (NN) identification (ID); or
an expected CSI report content type; and
in accordance with the received configuration of CSI report characteristics, generating a CSI report to transmit to the network; wherein,
the expected CSI report content type is a channel-based CSI output.

18. The method of claim 17, wherein:
the maximum size of the CSI report payload is determined based on a number of transmitting or receiving antenna ports at the UE.

19. A network device, comprising:
a transceiver; and
a processor configured to:
transmit, to a user equipment (UE) via the transceiver, a configuration of channel state information (CSI) report characteristics, the configuration of CSI report characteristics including one or more of:
a maximum size of a CSI report payload;
a maximum number of bits per layer or rank;
a neural network (NN) identification (ID); or
an expected CSI report content type; and
receive, from the UE via the transceiver, a CSI report generated by the UE in accordance with the transmitted configuration of CSI report characteristics.

20. The network device of claim 19, wherein:
the expected CSI report content type includes a precoder matrix indicator (PMI)-based CSI output or a channel-based CSI output.
